(19) United States
(12) Patent Application Publication
(10) Pub. No.: US 2019/0352547 A1
(43) Pub. Date: Nov. 21, 2019

(54) PRESSURE-SENSITIVE-ADHESIVE-LAYER-ATTACHED POLARIZING FILM AND IMAGE DISPLAY DEVICE

(71) Applicant: NITTO DENKO CORPORATION, Osaka (JP)

(72) Inventors: Masakuni Fujita, Ibaraki-shi (JP); Yusuke Toyama, Ibaraki-shi (JP); Yu Morimoto, Ibaraki-shi (JP)

(73) Assignee: NITTO DENKO CORPORATION, Ibaraki-shi, Osaka (JP)

(21) Appl. No.: 16/525,979

(22) Filed: Jul. 30, 2019

Related U.S. Application Data
(62) Division of application No. 15/708,461, filed on Sep. 19, 2017.

(30) Foreign Application Priority Data
Sep. 29, 2016 (JP) 2016-190933
Jul. 25, 2017 (JP) 2017-143510

(51) Int. Cl. C09J 133/08; C09J 7/38; G02F 1/1347; C09J 133/10; G02F 1/1335; G02B 5/30; G02F 1/1333

(52) U.S. Cl. CPC C09J 133/08; C09J 7/385; G02F 1/13471; C08F 226/08; G02F 1/133528; G02B 5/3033; G02F 1/133371; C09J 133/10

(57) ABSTRACT

A pressure-sensitive-adhesive-layer-attached polarizing film including a pressure-sensitive adhesive layer and a polarizing film, and is used, together with a transparent conductive substrate having a transparent conductive layer and a transparent substrate, in the state of being bonded to the transparent conductive layer, wherein a pressure-sensitive adhesive composition for forming the pressure-sensitive adhesive layer includes a (meth)acryl-based polymer and a thiol-group-containing silane coupling agent. The pressure-sensitive-adhesive-layer-attached polarizing film has a pressure-sensitive adhesive layer, having a high endurance even in the case of being bonded to a transparent conductive substrate having a transparent conductive layer and a transparent substrate, in particular, having an excellent endurance in a humidified environment and an excellent re-workability even in the same case, attached to a polarizing film.

### CROSS-REFERENCE

This application is a divisional of U.S. application Ser. No. 15/708,461 filed on Sep. 19, 2017, and is based upon and claims the benefits of priority from Japanese Patent Application No. 2016-190933 filed on Sep. 29, 2016 and Japanese Patent Application No. 2017-143510 filed on Jul. 25, 2017, the entire contents of which being incorporated herein by reference.

### BACKGROUND OF THE INVENTION

### Field of the Invention

The present invention relates to a pressure-sensitive-adhesive-layer-attached polarizing film which includes a pressure-sensitive adhesive layer and a polarizing film, and is used, together with a transparent conductive substrate having a transparent conductive layer and a transparent substrate, in the state of being bonded to the transparent conductive layer. The present invention also relates to an image display panel having a transparent conductive substrate to which the pressure-sensitive-adhesive-layer-attached polarizing film is applied. Furthermore, the present invention relates to an image display device including the image display panel.

### Background Art

In an image display panel, for example, a liquid crystal panel used in a liquid crystal display device or some other device, a polarizing film is usually laminated onto each of both sides of a liquid crystal cell, which is composed of a liquid crystal layer arranged between a pair of transparent substrates, to interpose a pressure-sensitive-adhesive layer between the cell and the polarizing film. Such a pressure-sensitive-adhesive layer is required to have a high endurance. For example, in an endurance test under heating and humidifying conditions, which is usually made as an environment accelerating test, the polarizing film is required not to undergo the generation of a peel or a lift, or other defects caused by the pressure-sensitive-adhesive layer.

Such pressure-sensitive-adhesive compositions for optical use have been variously investigated. Suggested is, for example, a pressure-sensitive-adhesive composition about which even when an optical film is bonded to the composition and subsequently the resultant is put into high-temperature and high-humidity conditions, the optical film is not peeled or foamed (see, for example, Patent Document 1).

### PRIOR ART DOCUMENT

### Patent Document

Patent Document 1: JP-A-2009-242767

### SUMMARY OF THE INVENTION

### Problems to be Solved by the Invention

About two transparent substrates of a liquid crystal cell as a constituent of a liquid crystal panel, a transparent conductive coating, such as an indium tin oxide (ITO) thin film, may be formed on one of the transparent substrates. A pressure-sensitive adhesive layer contacting this transparent conductive film tends to be peeled off, partially raised up or damaged into some other form to be lowered in endurance. This layer is remarkably lowered in endurance, particularly, in a humidified environment. A pressure-sensitive adhesive layer made from a pressure-sensitive adhesive composition in Patent Document 1 is bad in adhesiveness to an indium tin oxide (ITO) layer. This composition is insufficient as a pressure-sensitive adhesive composition toward a liquid crystal panel having a transparent conductive layer.

A pressure-sensitive adhesive layer designed to keep the heat resistance of this layer is high in adhesiveness to a transparent conductive layer. Accordingly, at the time of reworking a polarizing film having this pressure-sensitive adhesive layer bonded to a transparent conductive layer, a residue of its adhesive may be generated or the polarizing film may be broken out. The pressure-sensitive adhesive layer is also required to have a re-workability not permitting such inconveniences to be caused.

Accordingly, an object of the present invention is to provide a pressure-sensitive-adhesive-layer-attached polarizing film in which the following pressure-sensitive adhesive layer is attached to a polarizing film: a pressure-sensitive adhesive layer having a high endurance even in the case of being bonded to a transparent conductive substrate having a transparent conductive layer and a transparent substrate, in particular, having an excellent endurance in a humidified environment and an excellent re-workability even in the same case.

Another object of the present invention is to provide an image display panel having a transparent conductive substrate to which the pressure-sensitive-adhesive-layer-attached polarizing film is applied. Still another object of the invention is to provide an image display device including the image display panel.

### Means for Solving the Problems

In order to solve the problems, the present inventors have repeatedly made eager investigations to find out a pressure-sensitive-adhesive composition described below. Thus, the present invention has been achieved.

The present invention relates to a pressure-sensitive-adhesive-layer-attached polarizing film including: a pressure-sensitive adhesive layer and a polarizing film, which is used, together with a transparent conductive substrate having a transparent conductive layer and a transparent substrate, in the state of being bonded to the transparent conductive layer;

wherein a pressure-sensitive adhesive composition for forming the pressure-sensitive adhesive layer includes a (meth)acryl-based polymer and a thiol-group-containing silane coupling agent.

The thiol-group-containing silane coupling agent is preferably an oligomer thiol-group-containing silane coupling agent.

The thiol-group-containing silane coupling agent preferably has, in molecule thereof, two or more alkoxysilyl groups.

The blend amount of the thiol-group-containing silane coupling agent is preferably from 0.01 to 3 parts by weight for 100 parts by weight of the (meth)acryl-based polymer.

The thiol-group-containing silane coupling agent preferably has a thiol equivalent of 700 g/mol or less.

The present invention further relates to an image display panel, including: the pressure-sensitive-adhesive-layer-attached polarizing film; and a transparent conductive substrate having a transparent conductive layer and a transparent substrate;

wherein the pressure-sensitive-adhesive layer of the pressure-sensitive-adhesive-layer-attached polarizing film is bonded to the transparent conductive layer of the image display panel.

The present invention further relates to an image display device, including: the image display panel.

### Effect of the Invention

The pressure-sensitive adhesive composition, which is for forming the pressure-sensitive adhesive layer in the pressure-sensitive-adhesive-layer-attached polarizing film of the present invention, includes the thiol-group-containing silane coupling agent; therefore, this pressure-sensitive adhesive layer has a high endurance, in particular, an excellent endurance in a humidified environment even when bonded to a transparent conductive layer. Moreover, the pressure-sensitive adhesive layer is good in re-workability; thus, when the pressure-sensitive-adhesive-layer-attached polarizing film bonded to a transparent conductive layer is reworked, restrainable are the generation of a residue of its adhesive and the breaking of the polarizing film. As described herein, the pressure-sensitive-adhesive-layer-attached polarizing film of the present invention can attain compatibility between endurance and re-workability toward any transparent conductive layer. Moreover, the present invention makes it possible to provide an image display panel having this pressure-sensitive-adhesive-layer-attached polarizing film, and an image display device having this image display panel.

### BRIEF DESCRIPTION OF THE DRAWING

FIG. 1 is a schematic view which schematically illustrates an embodiment of a liquid crystal panel one of an image display panel usable in the present invention.

### MODE FOR CARRYING OUT THE INVENTION

### 1. Pressure-Sensitive Adhesive Composition

A pressure-sensitive adhesive composition in the present invention is used to form a pressure-sensitive adhesive layer, which is used, together with a transparent conductive substrate having a transparent conductive layer and a transparent substrate, in the state of being bonded to the transparent conductive layer. The pressure-sensitive adhesive composition includes a (meth)acryl-based polymer and a thiol-group-containing silane coupling agent. Hereinafter, a description will be made about the component-composition of the pressure-sensitive adhesive composition in the invention.

### (1) (Meth)Acryl-Based Polymer

The pressure-sensitive-adhesive composition of the present invention includes a (meth)acryl-based polymer, and a thiol-group-containing silane coupling agent. The composition preferably includes the (meth)acryl-based polymer as a main component. The main component denotes, out of entire solid components included in the pressure-sensitive-adhesive composition, a component the content by percentage of which in the composition is the largest. The main component denotes, out of the entire solid components included in the pressure-sensitive-adhesive composition, for example, a component the content by percentage of which in the composition is more than 50% by weight, and further, more than 70% by weight.

The (meth)acryl-based polymer usually includes, as a main component thereof, an alkyl (meth)acrylate for monomer units of the polymer. The wording “(meth)acrylate” denotes acrylate and/or methacrylate. In the present invention, the wording “(meth)a” has the same meaning.

The alkyl (meth)acrylate, which constitutes a main skeleton of the (meth)acryl-based polymer, is, for example, a (meth)acrylate having a linear or branched alkyl group having 1 to 18 carbon atoms. Examples of the alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These groups may be used singly or in any combination. The average number of carbon atoms in these alkyl groups is preferably from 3 to 9.

A monomer other than the alkyl (meth)acrylate, as a constituent for the (meth)acryl-based polymer, is, for example, a carboxyl-group-containing monomer, a hydroxyl-group-containing monomer, an amide-group-containing monomer, or an aromatic-ring-containing (meth)acrylate.

The carboxyl-group-containing monomer is a compound containing, in the structure thereof, a carboxyl group, and further containing therein a polymerizable unsaturated double bond of, for example, a (meth)acryloyl group or vinyl group. Specific examples of the carboxyl-group-containing monomer include (meth)acrylic acid, carboxylethyl (meth)acrylate, carboxylpentyl (meth)acrylate, itaconic acid, maleic acid, fumaric acid, and crotonic acid. Out of these carboxyl-group-containing monomers, acrylic acid is preferred from the viewpoint of the copolymerizability and costs thereof, and adhesive properties of the resultant pressure-sensitive-adhesive composition.

The hydroxyl-group-containing monomer is a compound containing, in the structure thereof, a hydroxyl group, and further containing therein a polymerizable unsaturated double bond of, for example, a (meth)acryloyl group or vinyl group. Specific examples of the hydroxyl-group-containing monomer include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; and (4-hydroxymethylcyclohexyl)-methyl acrylate. Out of these hydroxyl-group-containing monomers, preferred are 2-hydroxyethyl (meth)acrylate, and 4-hydroxybutyl (meth)acrylate, and particularly preferred is 4-hydroxybutyl (meth)acrylate from the viewpoint of the endurance of the resultant pressure-sensitive-adhesive layer.

The amide-group-containing monomer is a compound containing, in the structure thereof, an amide group, and further containing therein a polymerizable unsaturated double bond of, for example, a (meth)acryloyl group or vinyl group. Specific examples of the amide-group-containing monomer include (meth)acrylamide based monomers such as (meth)acrylamide, N,N-dimethyl(meth)acrylamide, N,N-diethyl(meth)acrylamide, N-isopropyl acrylamide, N-methyl(meth)acrylamide, N-butyl(meth)acrylamide, N-hexyl(meth)acrylamide, N-methylol(meth)acrylamide, N-methylol-N-propane(meth)acrylamide, aminomethyl(meth)acrylamide, aminoethyl(meth)acrylamide, mercaptomethyl(meth)acrylamide, and mercaptoethyl(meth)acrylamide; N-acryloyl heterocyclic monomers such as N-(meth)acryloylmorpholine, N-(meth)acryloylpiperidine, and N-(meth)acryloylpyrrolidine; and N-vinyl-group-containing lactam monomers such as N-vinylpyrrolidone and N-vinyl-ε-caprolactam. The amide-group-containing monomer is preferred for causing the pressure-sensitive-adhesive layer to satisfy endurance. Out of such amide-group-containing monomers, N-vinyl-group-containing lactam monomer is preferred to cause the pressure-sensitive-adhesive layer to attain compatibility between endurance and re-workability toward any transparent conductive layer.

The aromatic-ring-containing (meth)acrylate is a compound containing, in the structure thereof, an aromatic ring structure, and further containing a (meth)acryloyl group. Examples of the aromatic ring include a benzene ring, a naphthalene ring, and a biphenyl ring. The aromatic-ring-containing (meth)acrylate can cause the pressure-sensitive-adhesive layer to satisfy endurance (particularly, endurance for the transparent conductive layer).

Specific examples of the aromatic-ring-containing (meth)acrylate include aromatic-ring-containing (meth)acrylates each having a benzene ring, such as benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethylene glycol (meth)acrylate, ethylene oxide modified nonylphenol (meth)acrylate, ethylene oxide modified cresol (meth)acrylate, phenol ethylene oxide modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth)acrylate; aromatic-ring-containing (meth)acrylates each having a naphthalene ring, such as hydroxyethylated β-naphthol acrylate, 2-naphthoethyl (meth)acrylate, 2-naphthoxyethyl acrylate, and 2-(4-methoxy-1-naphthoxy)ethyl (meth)acrylate; and aromatic-ring-containing (meth)acrylates each having a biphenyl ring, such as biphenyl (meth)acrylate.

When the pressure-sensitive-adhesive composition contains a crosslinking agent, the carboxyl-group-containing monomer, hydroxyl-group-containing monomer, amide-group-containing monomer, and aromatic-ring-containing (meth)acrylate each become reaction points with the crosslinking agent. In particular, the carboxyl-group-containing monomer and hydroxyl-group-containing monomer are preferably used since the monomers are each rich in reactivity with an intermolecular crosslinking agent to improve the resultant pressure-sensitive-adhesive layer in cohesive property and heat resistance.

It is preferred that the (meth)acryl-based polymer used in the present invention includes, for its monomer units, each of the above-mentioned monomers in a proportion described below by weight of the entire constituent monomers (100% by weight).

The proportion by weight of the alkyl (meth)acrylate is set as the proportion of the remaining monomer except the monomers other than the alkyl (meth)acrylate. Specifically, the proportion is preferably 70% or more by weight. In order to cause the pressure-sensitive adhesive to ensure adhesion, it is preferred to set the proportion by weight of the alkyl (meth)acrylate into this range.

The proportion by weight of the carboxyl-group-containing monomer is preferably 2% or less by weight, more preferably from 0.01 to 2% by weight, even more preferably from 0.05 to 1.5% by weight, even more preferably from 0.05 to 1% by weight, in particular preferably from 0.05 to 0.5% by weight. If the proportion by weight of the carboxyl-group-containing monomer is less than 0.01% by weight, the tendency is generated that the pressure-sensitive-adhesive layer fails to satisfy endurance. In the meantime, if the proportion is more than 2% by weight, the tendency is generated that the pressure-sensitive-adhesive layer unfavorably comes to fail to attain compatibility between endurance and re-workability. In the meantime, if the proportion by weight is more than 2% by weight, the transparent conductive layer may be corroded so that the pressure-sensitive adhesive layer unfavorably tends not to attain compatibility between endurance and re-workability.

The proportion by weight of the hydroxyl-containing monomer is preferably 3% or less by weight, more preferably from 0.01 to 3% by weight, even more preferably from 0.1 to 2% by weight, in particular preferably from 0.2 to 2% by weight. If the proportion by weight of the hydroxyl-containing monomer is less than 0.01% by weight, the pressure-sensitive-adhesive layer becomes insufficient in being crosslinked so that the layer tends to fail to attain compatibility between endurance and re-workability, and adhesive properties. In the meantime, if the proportion is more than 3% by weight, the layer tends to fail to attain compatibility between endurance and re-workability.

The proportion by weight of the amide-group-containing monomer is preferably 8% or less by weight, more preferably from 0.1 to 8% by weight, even more preferably from 0.3 to 5% by weight, even more preferably from 0.3 to 4% by weight, in particular preferably from 0.7 to 2.5% by weight. If the proportion by weight of the amide-group-containing monomer is less than 0.1% by weight, the pressure-sensitive-adhesive layer tends to fail to attain compatibility between endurance and re-workability, particularly, for the transparent conductive layer. In the meantime, if the proportion is more than 8% by weight, the pressure-sensitive-adhesive layer unfavorably tends to fail to attain compatibility between endurance and re-workability.

The proportion by weight of the aromatic-ring-containing (meth)acrylate is preferably 25% or less by weight, more preferably from 0 to 22% by weight, even more preferably from 0 to 18% by weight. If the proportion by weight of the aromatic-ring-containing (meth)acrylate is more than 25% by weight, the pressure-sensitive-adhesive layer tends to fail to attain compatibility between endurance and re-workability.

It is unnecessary for the (meth)acryl-based polymer to contain, particularly, a monomer unit other than the above-mentioned monomer units. It is however possible to incorporate, into the polymer, one or more copolymerizable monomers having a polymerizable functional group having an unsaturated double bond, such as a (meth)acryloyl group or vinyl group, to improve the pressure-sensitive-adhesive layer in adhesion or heat resistance.

About the proportion of the copolymerizable monomer (s) in the (meth)acryl-based polymer, the proportion by weight of the copolymerizable monomer (s) is preferably from about 0 to 10% by weight, more preferably from about 0 to 7% by weight, even more preferably from about 0 to 5% by weight of the entire constituent monomers (100% by weight) of the (meth)acryl-based polymer.

The (meth)acryl-based polymer in the present invention is usually a polymer having a weight-average molecular weight of 1,000,000 to 2,500,000. The weight-average molecular weight is preferably from 1,200,000 to 2,000,000, considering the endurance, in particular, the heat resistance of the pressure-sensitive-adhesive layer. If the weight-average molecular weight is less than 1,000,000, the polymer is unfavorable from the viewpoint of heat resistance. If the weight-average molecular weight is more than 2,500,000, the pressure-sensitive adhesive tends to become hard easily so that a member bonded through this adhesive is easily peeled off. The “weight-average molecular weight (Mw)”/“number-average molecular weight (Mn)” ratio, which shows the molecular weight distribution of the polymer, is preferably from 1.8 or more to 10 or less, more preferably from 1.8 to 7, even more preferably from 1.8 to 5. If the molecular weight distribution (Mw/Mn) is more than 10, the pressure-sensitive-adhesive layer is unfavorable from the viewpoint of endurance. The weight-average molecular weight and the molecular weight distribution (Mw/Mn) are each gained from a value obtained by measuring the polymer by GPC (gel permeation chromatography) and then calculating the molecular weight of the polymer in terms of polystyrene.

Such a (meth)acryl-based polymer may be produced by a method selected appropriately from known production methods such as solution polymerization, bulk polymerization, emulsion polymerization and various radical polymerizations. The resultant (meth)acryl-based polymer may be any one of a random copolymer, a block copolymer, a graft copolymer and other polymers.

In the solution polymerization, as a polymerization solvent, for example, ethyl acetate or toluene is used. In a specific example of the solution polymerization, reaction is performed in the presence of an added polymerization initiator in an inert gas, such as nitrogen, ordinarily under reaction conditions of a temperature of about 50 to 70° C. and a period of about 5 to 30 hours.

A polymerization initiator, a chain transfer agent, an emulsifier and others that are used in the radical polymerizations are not particularly limited, and may be appropriately selected to be used. The weight-average molecular weight of the (meth)acryl-based polymer is controllable in accordance with the respective use amounts of the polymerization initiator and the chain transfer agent, and the reaction conditions. In accordance with the species of these agents, the use amounts thereof are appropriately adjusted.

Examples of the polymerization initiator include azo initiators such as 2,2′-azobisisobutyronitrile, 2,2′-azobis(2-amidinopropane) dihydrochloride, 2,2′-azobis[2-(5-methyl-2-imidazoline-2-yl)propane] dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine] hydrate (trade name: VA-057, manufactured by Wako Pure Chemical Industries, Ltd.); persulfates such as potassium persulfate, and ammonium persulfate; peroxide initiators such as di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy) cyclohexane, t-butyl hydroperoxide, and hydrogen peroxide; redox initiators, which are each a combination of a peroxide with a reducing agent, such as a combination of a persulfate with sodium hydrogensulfite, and a combination of a peroxide with sodium ascorbate. However, the polymerization initiator is not limited to these examples.

Such polymerization initiators may be used singly or in the form of a mixture of two or more thereof. The content of the whole of the initiator (s) is preferably from about 0.005 to 1 part by weight, more preferably from about 0.02 to 0.5 parts by weight for 100 parts by weight of the entire monomer component(s).

In order to use, for example, 2,2′-azoisobutyronitrile as the polymerization initiator to produce a (meth)acryl-based polymer having a weight-average molecular weight in the above-mentioned range, the use amount of the polymerization initiator(s) is preferably from about 0.06 to 0.2 part by weight, more preferably from about 0.08 to 0.175 parts by weight for 100 parts by weight of the entire monomer component(s).

The chain transfer agent, the emulsifier, and other components may be used appropriately selected from conventionally known agents and components.

### (2) Thiol-Group-Containing Silane Coupling Agent

In the present invention, the pressure-sensitive adhesive composition includes a thiol-group-containing silane coupling agent. This thiol-group-containing silane coupling agent, which is included in the pressure-sensitive adhesive composition, makes it possible to improve the endurance of a pressure-sensitive adhesive layer made from the pressure-sensitive adhesive composition, in particular, to make this layer compatible between an excellent endurance in a humidified environment, and re-workability. Additionally, among kinds of the thiol-group-containing silane coupling agent, an oligomer thiol-group-containing silane coupling agent is particularly preferred. The oligomer type denotes any multi-mer or polymer that is in a range from a dimer made from monomers to a hecto-mer or the like made from about 100 monomers. The weight-average molecular weight of the oligomer silane coupling agent is preferably from about 300 to about 30000.

The oligomer thiol-group-containing silane coupling agent is preferably an oligomer thiol-group-containing silane coupling agent having, in the molecule thereof, two or more alkoxysilyl groups. Specific examples thereof include products, X-41-1805, X-41-1810 and X-41-1818, manufactured by Shin-Etsu Chemical Co., Ltd. These coupling agents are preferred since the agents volatilize less easily, and produce, because of the alkoxysilyl groups thereof, an advantageous effect of an improvement in the endurance and the re-workability.

The thiol-group-containing silane coupling agent that is not of any oligomer type is, for example, 3-mercaptopropyltrimethoxysilane or γ-mercaptopropylmethyldimethoxysilane. A specific example thereof is a product, KBM-803, manufactured by Shin-Etsu Chemical Co., Ltd.

The number of the alkoxysilyl groups in the thiol-group-containing silane coupling agent is not particularly limited, and is preferably 2 or more in the molecule thereof. The proportion of the alkoxy groups in the thiol-group-containing silane coupling agent is preferably from 10 to 60%, more preferably from 20 to 50%, even more preferably from 20 to 40% by weight of the silane coupling agent.

The kinds of any one of the alkoxy groups is not particularly limited, and is, for example, an alkoxy group having 1 to 6 carbon atoms, examples thereof including methoxy, ethoxy, propoxy, butoxy, pentyloxy, and hexyloxy. Out of these groups, methoxy and ethoxy are preferred, and methoxy is more preferred. It is also preferred that any one molecule of the thiol-group-containing silane coupling agent contains both of methoxy and ethoxy.

The thiol equivalent (mercapto equivalent) of the thiol-group-containing silane coupling agent is preferably 1000 g/mol or less, more preferably 800 g/mol or less, even more preferably 700 g/mol or less, even more preferably 500 g/mol or less. The lower limit value of the thiol equivalent is not particularly limited. In the case of the oligomer thiol-group-containing silane coupling agent, the value is preferably, for example, 200 g/mol or more.

Such thiol-group-containing silane coupling agents (particularly, such oligomer thiol-group-containing silane coupling agents) may be used singly or in the form of a mixture of two or more thereof. The content of the whole of the thiol-group-containing silane coupling agent(s) is preferably from 0.01 to 6 parts, more preferably from 0.01 to 3 parts, even more preferably from 0.05 to 1 part by weight for 100 parts by weight of the (meth)acryl-based polymer. When the pressure-sensitive-adhesive composition includes the thiol-group-containing silane coupling agent in the ranges, the resultant pressure-sensitive adhesive layer can be improved in endurance and can especially attain compatibility between an excellent endurance in a humidified environment and re-workability.

A silane coupling agent other than the above-defined thiol-group-containing silane coupling agent may be added to the pressure-sensitive-adhesive composition used in the present invention. Examples of the other coupling agent include amino-group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acryl-group-containing silane coupling agents such as 3-acryloxypropyltrimethoxysilane, and 3-methacryloxypropyltriethoxysilane; and isocyanate-group-containing silane coupling agents such as 3-isocyanatepropyltriethoxysilane.

The silane coupling agent other than the above-defined thiol-group-containing silane coupling agent may be added to the composition as far as the agent does not damage the advantageous effects of the present invention. The addition amount thereof is not particularly limited.

### (3) Crosslinking Agent

The pressure-sensitive-adhesive composition used in the present invention preferably includes a crosslinking agent. The crosslinking agent may be an organic crosslinking agent, or a polyfunctional metal chelate. Examples of the organic crosslinking agent include isocyanate based, peroxide based, epoxy based, and imine based crosslinking agents. The polyfunctional metal chelate is a compound in which a polyvalent metal is covalently bonded or coordinate-bonded to an organic compound. Examples of the atom of the polyvalent metal include Al, Cr, Zr, Co, Cu, Fe, Ni, V, Zn, In, Ca, Mg, Mn, Y, Ce, Sr, Ba, Mo, La, Sn, and Ti. An atom in the organic compound to which the metal is covalently bonded or coordinate-bonded is, for example, an oxygen atom. Examples of the organic compound include alkyl esters, alcohol compounds, carboxylic acid compounds, ether compounds, and ketone compounds.

As the crosslinking agent, an isocyanate based crosslinking agent and/or a peroxide based crosslinking agent is/are preferably used. A combination of an isocyanate based crosslinking agent with a peroxide based crosslinking agent is more preferably used.

The isocyanate based crosslinking agent may be a compound having at least two isocyanate groups. The crosslinking agent is, for example, a known aliphatic polyisocyanate, alicyclic polyisocyanate, or aromatic polyisocyanate that is ordinarily used in urethanization reaction.

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the alicyclic isocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Additional examples of the isocyanate based crosslinking agent include respective multi-merized bodies (dimers, trimers and pentamers) of the above-mentioned diisocyanates; and urethane modified bodies obtained by causing an isocyanate to react with a polyhydric alcohol such as trimethylolpropane, urea modified bodies, biuret modified bodies, allophanate modified bodies, isocyanurate modified bodies, and carbodiimide modified bodies.

Examples of commercially available products of the isocyanate based crosslinking agent include products with trade names “MILLIONATE MT”, “MILLIONATE MTL”, “MILLIONATE MR-200”, “MILLIONATE MR-400”, “CORONATE L”, “CORONATE HL” and “CORONATE HX” each manufactured Nippon Polyurethane Industry Co., Ltd; and products with trade names “TAKENATE D-110N”, “TAKENATE D-120N”, “TAKENATE D-140N”, “TAKENATE D-160N”, “TAKENATE D-165N”, “TAKENATE D-17OHN”, “TAKENATE D-178N”, “TAKENATE 500”, and “TAKENATE 600” each manufactured by Mitsui Chemicals, Inc. These compounds may be used singly or in the form of a mixture of two or more thereof.

As the isocyanate based crosslinking agent, preferred are any aliphatic polyisocyanate, and an aliphatic polyisocyanate type compound that is a modified body of the aliphatic polyisocyanate. The aliphatic polyisocyanate based compound is richer in crosslinked-structure flexibility than other isocyanate based crosslinking agents to relieve, with ease, stress in the pressure-sensitive-adhesive layer that follows the expansion/shrinkage of the optical film. Thus, the optical film is not easily peeled in an endurance test. The aliphatic polyisocyanate based compound is in particular preferably hexamethylene diisocyanate, and any modified body thereof.

As the peroxide, the following peroxide is appropriately usable: a peroxide which is heated or irradiated with light to generate active radical species, thereby advancing the crosslinkage of the base polymer ((meth)acryl-based polymer) of the pressure-sensitive-adhesive composition. A peroxide having a one-minute half-life temperature of 80 to 160° C. is preferably used, and a peroxide having a one-minute half-life temperature of 90 to 140° C. is more preferably used, considering the workability and the stability thereof.

Examples of the usable peroxide include di(2-ethylhexyl) peroxydicarbonate (one-minute half-life temperature: 90.6° C.), di(4-t-butylcyclohexyl) peroxydicarbonate (one-minute half-life temperature: 92.1° C.), di-sec-butyl peroxydicarbonate (one-minute half-life temperature: 92.4° C.), t-butyl peroxyneodecanoate (one-minute half-life temperature: 103.5° C.), t-hexyl peroxypivalate (one-minute half-life temperature: 109.1° C.), t-butyl peroxypivalate (one-minute half-life temperature: 110.3° C.), dilauroyl peroxide (one-minute half-life temperature: 116.4° C.), di-n-octanoyl peroxide (one-minute half-life temperature: 117.4° C.), 1,1,3,3-tetramethylbutyl peroxy-2-ethylhexanoate (one-minute half-life temperature: 124.3° C.), di(4-metnylbenzoyl) peroxide (one-minute half-life temperature: 128.2° C.), dibenzoyl peroxide (one-minute half-life temperature: 130.0° C.), t-butyl peroxyisobutyrate (one-minute half-life temperature: 136.1° C.), and 1,1-di(t-hexylperoxy)cyclohexane (one-minute half-life temperature: 149.2° C.). Out of these examples, preferred are di(4-t-butylcyclohexyl) peroxydicarbonate (one-minute half-life temperature: 92.1° C.), dilauroyl peroxide (one-minute half-life temperature: 116.4° C.), and dibenzoyl peroxide (one-minute half-life temperature: 130.0° C.) since these compounds are excellent, especially in crosslinking reaction efficiency.

The half-life of a peroxide is an index representing the decomposition rate of the peroxide, and denotes a period until the remaining amount of the peroxide becomes half. Manufactures' catalogs and others describe the decomposition temperature of each of various peroxides at which the peroxide obtains a half-life of any period, and the half-life period of the peroxide at any temperature. For example, “ORGANIC PEROXIDES 9^{th} version (May, 2003)” of NOF Corp. describes these factors.

The use amount of the crosslinking agent is preferably from 0.01 to 3 parts by weight, more preferably from 0.02 to 2 parts by weight, even more preferably from 0.03 to 1 part by weight for 100 parts by weight of the (meth)acryl-based polymer. If the amount is less than 0.01 part by weight, the pressure-sensitive-adhesive layer becomes insufficient in being crosslinked so that the pressure-sensitive-adhesive layer may not unfavorably satisfy endurance and adhesive properties. In the meantime, if the amount is more than 3 parts by weight, the pressure-sensitive-adhesive layer tends to become excessively hard to be lowered in endurance.

Isocyanate based crosslinking agents as described above may be used singly or in the form of a mixture of two or more thereof. The content of the entire crosslinking agent(s) is preferably from 0.01 to 2 parts by weight, more preferably from 0.02 to 2 parts by weight, even more preferably from 0.05 to 1.5 parts by weight for 100 parts by weight of the (meth)acryl-based polymer. The crosslinking agent(s) may be appropriately incorporated into the composition, considering the cohesive strength of the pressure-sensitive-adhesive layer, and the prevention of the peel in the endurance test.

Peroxides as described above may be used singly or in the form of a mixture of two or more thereof. The content of the entire peroxide(s) is preferably from 0.01 to 2 parts by weight, more preferably from 0.04 to 1.5 parts by weight, even more preferably from 0.05 to 1 parts by weight for 100 parts by weight of the (meth)acryl-based polymer. The content is appropriately selected in these ranges to adjust, for example, the workability and the crosslinkage stability of the composition.

### (4) Ionic Compound

The pressure-sensitive-adhesive composition of the present invention may further include an ionic compound. The ionic compound is not particularly limited. Such a compound used in the present field is suitably usable. Examples thereof include ionic compounds described in JP-A-2015-4861. Out of these examples, preferred are lithium salts of (perfluoroalkylsulfonyl) imide, and more preferred is bis(trifluoromethanesulfonylimide) lithium. The proportion of the ionic compound is not particularly limited. The proportion may be set into any range as far as the advantageous effects of the present invention are not damaged. The amount of the ionic compound is, for example, preferably 10 parts by weight or less, more preferably 5 parts by weight or less, even more preferably 3 parts by weight or less, in particular preferably 1 part by weight or less for 100 parts by weight of the (meth)acryl-based polymer.

### (5) Others

A polyether compound having a reactive silyl group may be blended into the pressure-sensitive-adhesive composition used in the present invention. The polyether compound can favorably improve the composition in re-workability. The polyether compound may be, for example, any polyether compound disclosed in JP-A-2010-275522. The addition amount thereof may be appropriately determined into any range as far as the advantageous effects of the present invention are not damaged.

The pressure-sensitive-adhesive composition of the present invention may further include known additives. For example, the following may be appropriately added to the composition in accordance with an article in which the composition is used: polyether compounds of a polyalkylene glycol such as polypropylene glycol; powder of a colorant or a pigment; dyes; surfactants; plasticizers; tackifiers; surface lubricants; leveling agents; softeners; antioxidants; antiaging agents; light stabilizers; ultraviolet absorbents; polymerization inhibitors; inorganic or organic fillers; metal powder; and granular or foil-piece-form substances. A redox system, to which a reducing agent is added, may be used as far as the system is controllable. These additives are used in an amount that is preferably 5 parts by weight or less, more preferably 3 parts by weight or less, even more preferably 1 part by weight or less for 100 parts by weight of the (meth)acryl-based polymer.

### 2. Pressure-Sensitive-Adhesive Layer For Transparent Conductive Layer

The pressure-sensitive-adhesive layer for transparent conductive layer of the present invention is formed from the above-mentioned pressure-sensitive-adhesive composition. When the pressure-sensitive-adhesive layer is formed, it is preferred to sufficiently consider effects of the crosslinking treatment temperature and the crosslinking treatment period, as well as adjust the amount of the whole of the crosslinking agent(s) added to the layer.

In accordance with the used crosslinking agent(s), the crosslinking treatment temperature and the crosslinking treatment period are adjustable. The crosslinking treatment temperature is preferably 170° C. or lower. The crosslinking treatment may be conducted at the same temperature as in the step of drying the pressure-sensitive-adhesive layer; or after the drying step, a separate crosslinking treatment step may be set up and performed. The crosslinking treatment period may be set, considering the producing performance or working performance of the layer-forming-process. The period is usually from about 0.2 to 20 minutes, preferably from about 0.5 to 10 minutes.

The method for forming the pressure-sensitive-adhesive layer is not particularly limited, and may be a method of applying the pressure-sensitive-adhesive composition onto a substrate that may be of various types, using a drying machine such as a hot oven to dry the workpiece to volatilize the solvent and others, optionally subjecting the workpiece to a crosslinking treatment as described above to form a pressure-sensitive-adhesive layer, and then transferring the pressure-sensitive-adhesive layer onto a polarizing film or transparent conductive substrate, which will be detailed later, or applying the pressure-sensitive-adhesive composition directly onto the same polarizing film or transparent conductive substrate as described above to form the target pressure-sensitive-adhesive layer. In the present invention, preferred is a method of producing a pressure-sensitive-adhesive-layer-attached polarizing film beforehand in which the pressure-sensitive-adhesive layer is formed on a polarizing film, and then bonding the pressure-sensitive-adhesive-layer-attached polarizing film onto a transparent conductive substrate.

The substrate is not particularly limited. The substrate may be a substrate that may be of various types, such as a release film, a transparent resin film substrate, and a polarizing film, which will be detailed later.

As the method for applying the pressure-sensitive-adhesive composition onto the substrate or polarizing film, various methods may be used. Specific examples thereof are extrusion coating methods such as a fountain coater, roll coating, kiss roll coating, gravure coating, reverse coating, roll brush coating, spray coating, dip roll coating, bar coating, knife coating, air knife coating, curtain coating, lip coating, or a die coater.

The drying conditions (temperature and period) are not particularly limited, and may be appropriately set in accordance with, for example, the composition and the concentration of the pressure-sensitive-adhesive composition. The temperature is, for example, from 80 to 200° C., preferably from 90 to 170° C., and the period is from 1 to 60 minutes, preferably from 2 to 30 minutes.

After the drying, the workpiece may be optionally subjected to crosslinking treatment. Conditions therefor are as described above.

The thickness of the (dried) pressure-sensitive-adhesive layer is, for example, preferably from 5 to 100 μm, more preferably from 7 to 70 μm, even more preferably from 10 to 50 μm. If the thickness of the pressure-sensitive-adhesive layer is less than 5 μm, the layer tends to become poor in tackiness onto an adherend to be insufficient in endurance under humidified conditions. In the meantime, if the thickness of the pressure-sensitive-adhesive layer is more than 100 μm, the pressure-sensitive-adhesive composition is not sufficiently dried when applied and dried to form the pressure-sensitive-adhesive layer; thus, foams remains in the layer or thickness unevenness is generated in the pressure-sensitive-adhesive layer surfaces. Consequently, a problem about the external appearance of the layer tends to become apparent with ease.

Examples of a constituent of the above-mentioned release film include resin films such as polyethylene, polypropylene, polyethylene terephthalate and polyester films, porous matters such as paper, fabric and nonwoven fabric pieces, nets, foamed sheets, metal foil pieces, laminates each made of two or more of these examples, and other appropriate thin pieces. The resin film is preferably used since the film is excellent in surface smoothness.

Examples of the resin film include polyethylene film, polypropylene film, polybutene film, polybutadiene film, polymethylpentene film, polyvinyl chloride film, vinyl chloride copolymer film, polyethylene terephthalate film, polybutylene terephthalate film, polyurethane film, and ethylene-vinyl acetate copolymer film.

The thickness of the release film is usually from 5 to 200 μm, preferably from about 5 to 100 μm. The release film may be optionally subjected to releasing treatment and antifouling treatment with, for example, a silicone based, fluorine-containing based, long-chain-alkyl based or aliphatic acid amide based release agent, or silica powder, and/or antistatic treatment in, for example, a painting, kneading-in or vapor deposition manner. By subjecting the surface(s) of the release film appropriately to, particularly, peeling treatment, such as silicone treatment, long-chain alkyl treatment or fluorine treatment, this film can be made higher in peeling property from the pressure-sensitive-adhesive layer.

The transparent resin film substrate is not particularly limited, and may be a transparent resin film that may be of various types. The resin film is made of a monolayered film. Examples of the raw material thereof include polyester based resins such as polyethylene terephthalate and polyethylene naphthalate, acetate based resins, polyethersulfone based resins, polycarbonate based resins, polyamide based resins, polyimide based resins, polyolefin based resins, (meth)acrylic resins, polyvinyl chloride based resins, polyvinylidene chloride based resins, polystyrene based resins, polyvinyl alcohol based resins, polyarylate based resins, and polyphenylene sulfide based resins. Out of these based resins, particularly preferred are polyester based resins, polyimide based resins and polyethersulfone based resins.

The thickness of the film substrate is preferably from 15 to 200 μm.

### 3. Pressure-Sensitive-Adhesive-Layer-Attached Polarizing Film

The pressure-sensitive-adhesive-layer-attached polarizing film of the present invention has the above-defined pressure-sensitive-adhesive layer over at least one surface of a polarizing film. The pressure-sensitive-adhesive-layer-attached polarizing film is used together with a transparent conductive substrate having a transparent conductive layer and a transparent substrate, in the state of being bonded to the transparent conductive layer.

The method for forming the pressure-sensitive-adhesive layer is as described above.

The polarizing film is not particularly limited, and is generally a polarizing film having a transparent protective film or transparent protective films on one surface or both surfaces of a polarizer.

The polarizer is not particularly limited, and may be a polarizer that may be of various types. The polarizer may be, for example, a polarizer yielded by causing a dichroic substance, such as iodine or a dichroic dye, to be adsorbed into a hydrophilic polymeric film, such as a polyvinyl alcohol based film, a polyvinyl alcohol based film converted partially to formal or a partially saponified ethylene/vinyl acetate copolymer based film, and then stretching the resultant uniaxially; or a polyene based oriented film of, for example, a polyvinyl-alcohol-dehydrated product or a polyvinyl chloride de-hydrochloride-treated product. Out of such examples, preferred is a polarizer composed of a polyvinyl alcohol based film and a dichroic substance such as iodine. More preferred is an iodine-containing polarizer containing iodine and/or an iodine ion. The thickness of these polarizers is not particularly limited, and is generally from about 5 to 80 μm.

The polarizer yielded by dyeing a polyvinyl alcohol based film with iodine, and then stretching the resultant uniaxially may be produced, for example, by immersing a polyvinyl alcohol into an aqueous solution of iodine to dye the polyvinyl alcohol, and then stretching the resultant into a length 3 to 7 times the original length. The polyvinyl alcohol may be immersed into, for example, an aqueous solution of potassium iodine that may optionally contain, for example, boric acid, zinc sulfate or zinc chloride. Furthermore, before the dyeing, the polyvinyl alcohol film may be optionally immersed into water to be cleaned therewith. The cleaning of the polyvinyl alcohol based film with water makes it possible to clean away stains and an anti-blocking agent on the outer surface (s) of the polyvinyl alcohol based film. Furthermore, the polyvinyl alcohol based film is swollen to produce an advantageous effect of preventing dyeing-unevenness or some other unevenness. After or while dyed with iodine, the film may be stretched. Alternatively, after stretched, the film may be dyed with iodine. The stretching may be performed in an aqueous solution of, for example, boric acid or potassium iodide, or in a water bath.

In the present invention, a thin polarizer of 10 μm or less in thickness may be used. From the viewpoint of making the pressure-sensitive-adhesive-layer-attached polarizing film thinner, the thickness is preferably from 1 to 7 μm. Such a thin polarizer is preferred since the polarizer is small in thickness unevenness, is excellent in visibility, and is small in dimension change to be excellent in endurance, and can further make the resultant polarizing film also small in thickness.

Typical examples of the thin polarizer include thin polarizing membranes described in JP-A-S51-069644, JP-A-2000-338329, WO 2010/100917 pamphlet, Japanese Patent No. 4751481, or JP-A-2012-073563. These thin polarizing membranes can each be obtained by a producing method including the step of stretching a polyvinyl alcohol based resin (hereinafter referred to also as a PVA based resin) layer and a resin substrate for stretching in a laminated state, and the step of dyeing the workpiece. Even when the PVA based resin layer is thin, this producing method makes it possible to stretch the layer without undergoing any inconvenience based on the stretching, such as breaking, by the matter that the layer is supported on the resin substrate for stretching.

The thin polarizing membrane is preferably a membrane obtained by the following producing method, out of producing methods including the step of stretching the laminated-state members and the step of dyeing the resultant, since the laminate can be stretched into a high stretch ratio to improve the resultant in polarizing performance: a method including the step of stretching the members in an aqueous solution of boric acid, as described in WO 2010/100917 pamphlet, Japanese Patent No. 4751481, or JP-A-2012-073563. Particularly preferred is a thin polarizing membrane yielded by the producing method including the step of stretching the members auxiliarily in the air before the stretching in the aqueous solution of boric acid, as described in Japanese Patent No. 4751481, or JP-A-2012-073563.

The material for forming the transparent protective film laid on one or each of the two surfaces of the polarizer may be, for example, a thermoplastic resin excellent in transparency, mechanical strength, thermal stability, water blocking performance, isotropy, and others. Specific examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic polyolefin resins (norbornene based resins), polyarylate resins, polystyrene resins and polyvinyl alcohol resins; and any mixture of two or more thereof. The transparent protective film is bonded onto one of the two sides of the polarizer through an adhesive layer. As a transparent protective film on the other side, a thermosetting resin or ultraviolet-ray curing-type resin may be used, examples thereof including (meth)acrylic, urethane, acrylic urethane, epoxy and silicone based resins. Each of the transparent protective films may contain one or more arbitrarily-selected appropriate additives. Examples of the additives include ultraviolet absorbents, antioxidants, lubricants, plasticizers, release agents, anti-coloring agents, flame retardants, nucleating agents, antistatic agents, pigments, and colorants. The content of the thermoplastic resin in the transparent protective film is preferably from 50 to 100% by weight, more preferably from 50 to 99% by weight, even more preferably from 60 to 98% by weight, in particular preferably from 70 to 97% by weight. If the content of the thermoplastic resin in the transparent protective film is 50% by weight or less, it is feared that a high transparency and others that the thermoplastic resin originally has cannot be sufficiently expressed.

The thickness of the transparent protective film may be appropriately determined. The thickness is generally from about 1 to 500 μm from the viewpoint of the workabilities of the film, such as the strength and handleability, and the thin film property of the film.

The polarizer and the protective film are usually caused to adhere closely onto each other through, for example, a water-based adhesive. Examples of the water-based adhesive include isocyanate based adhesives, polyvinyl alcohol based adhesives, gelatin based adhesives, vinyl latex based adhesives, water based polyurethanes, and water based polyesters. Examples of the adhesive for the polarizer and the transparent protective film include, besides the above-mentioned adhesives, ultraviolet-ray curing-type adhesives, and electron-beam curing-type adhesives. The electron-beam curing-type adhesives, for polarizing films, show adhesion suitable for the above-mentioned various transparent protective films. The adhesive used in the present invention may contain a metal compound filler.

In the present invention, instead of the transparent protective film of the polarizing film, for example, a retardation film can be formed on the polarizer. On the transparent protective film, another transparent protective film or, for example, a retardation film can be laid.

The transparent protective film surface onto which the polarizer is not bonded may be subjected to a hard coat layer or anti-reflection treatment, or a treatment for sticking-prevention or for diffusion or anti-glare.

The pressure-sensitive-adhesive-layer-attached polarizing film may have an anchor layer between the polarizing film and the pressure-sensitive-adhesive layer. The material for forming the anchor layer is not particularly limited. Examples thereof include various polymers, respective sols of metal oxides, and silica sol. Out of these examples, particularly preferred are polymers. The use form of each of the polymers may be any one of solvent-soluble, water-dispersible, and water-soluble forms.

Examples of the polymers include polyurethane based resins, polyester based resins, acrylic based resins, polyether based resins, cellulose based resins, polyvinyl alcohol based resins, polyvinyl pyrrolidone, and polystyrene based resins.

When the pressure-sensitive-adhesive layer of the pressure-sensitive-adhesive-layer-attached polarizing film is exposed, the pressure-sensitive-adhesive layer may be protected by a release film (separator) until the polarizing film is put into practical use. The release film may be the same as described above. In a case where in the production of the pressure-sensitive-adhesive layer, as its substrate a release film is used, the pressure-sensitive-adhesive layer on the release film may be bonded to a polarizing film; in this case, this release film is usable as a release film for the pressure-sensitive-adhesive layer of the resultant pressure-sensitive-adhesive-layer-attached polarizing film. Thus, the process can be made simple.

The pressure-sensitive-adhesive-layer-attached polarizing film of the present invention is usable, together with a transparent conductive substrate having a transparent conductive layer and a transparent substrate.

The constituent material of the transparent conductive layer of the transparent conductive substrate is not particularly limited, and may be a metal oxide of at least one metal selected from the group consisting of indium, tin, zinc, gallium, antimony, titanium, silicon, zirconium, magnesium, aluminum, gold, silver, copper, palladium, and tungsten. The metal oxide may optionally include any one of the metal atoms described in this group. Preferred is the use of, for example, indium oxide including tin oxide (ITO) or tin oxide including antimony. The use of ITO is particularly preferred. ITO preferably includes 80 to 99% by weight of indium oxide, and 1 to 20% by weight of tin oxide.

The compound ITO may be crystalline ITO, or amorphous ITO. Each of the two ITO species is preferably usable.

Examples of the transparent conductive layer of the transparent conductive substrate include a metal mesh, in which fine metal lines are made in the form of a lattice pattern, and a layer formed through coating with fine metal particles. The metal material constituting the layer may be any appropriate metal (examples thereof including alloy materials) as far as the metal material is a metal high in conductivity. Specifically, the metal material is preferably, for example, one or more metals selected from the group consisting of gold, platinum, silver, aluminum, and copper. From the viewpoint of conductivity, aluminum, silver, copper or gold is preferred.

The transparent conductive layer of the transparent conductive substrate may be a layer made of an organic conductive membrane. A material for forming the organic conductive membrane is not particularly limited, and is, for example, a conductive polymer, an ionic conductive composition composed of an electrolytic salt and an organopolysiloxane, an ionic compound, and a surfactant that may be of various types (such as a cationic, anionic or amphoteric surfactant). Out of these materials, a conductive polymer is preferably used from the viewpoint of optical properties, the external appearance and an antistatic effect thereof, and the stability of the antistatic effect when the transparent conductive layer is heated or humidified. A conductive polymer, such as polyaniline or polythiophene, is in particular preferably used. About such a conductive polymer, usable is any one of water-soluble, water-dispersible, organic-solvent-soluble, and organic-solvent-dispersible types. About the water-soluble or water-dispersible conductive polymer, a coating liquid thereof can be prepared in the form of a solution in water, or a dispersion in water when an antistatic layer is made from the polymer, so that the coating liquid does not need any non-aqueous organic solvent. It is therefore possible to restrain a denaturation of the transparent substrate by the organic solvent. The solution in water or dispersion in water may contain an aqueous solvent besides water. The aqueous solvent is, for example, an alcohol, such as methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, or cyclohexanol.

The water-soluble conductive polymer or the water-dispersible conductive polymer such as polyaniline or polythiophene preferably has, in the molecule thereof, a hydrophilic functional group. Examples of the hydrophilic functional group include a sulfonic group, an amino group, an amide group, an imino group, a quaternary ammonium salt group, a hydroxyl group, a mercapto group, a hydrazino group, a carboxyl group, a sulfate group and a phosphate group; and salts of these groups. When the polymer has, in the molecule thereof, the hydrophilic functional group, the polymer easily becomes soluble in water or dispersible therein in the form of fine particles. Thus, the water-soluble conductive polymer or the water-dispersible conductive polymer is easily preparable.

An example of a commercially available product of the water-soluble conductive polymer is polyanilinesulfonic acid (manufactured by Mitsubishi Rayon Co., Ltd.; weight-average molecular weight in terms of that of polystyrene: 150,000). Examples of a commercially available product of the water-dispersible conductive polymer include polythiophene based conductive polymers (their trade name: DENATRON series, manufactured by Nagase ChemteX Corp.)

A binder component may be added to the conductive polymer to improve the conductive polymer in formability into a coating film, and adhesiveness to a transparent substrate. When the conductive polymer is an aqueous material that is a water-soluble conductive polymer or water-dispersible conductive polymer, a water-soluble or water dispersible binder component is used. Examples of the binder include oxazoline-group-containing polymers, polyurethane resins, polyester resins, acrylic resins, polyether resins, cellulose resins, polyvinyl alcohol resins, epoxy resins, polyvinyl pyrrolidone, polystyrene resins, polyethylene glycol, and pentaerythritol. Particularly preferred are polyurethane resins, polyester resins, and acrylic resins. One or more of these binders may be appropriately used in accordance with the usage thereof.

The use amount of each of the conductive polymer and the binder, which depends on the kinds thereof, is preferably controlled to adjust the surface resistivity value of the resultant transparent conductive membrane into the range of 1×10⁸ to 1×10¹²Ω/□.

The organic conductive layer used in the present invention may further contain some other known dopant. For example, the following may be appropriately added thereto in accordance with the usage purpose: powder of a colorant or pigment, a dye, a surfactant, a plasticizer, a surface lubricant, a levelling agent, a softener, an antioxidant, an antiaging agent, a light stabilizer, an ultraviolet absorbent, a polymerization inhibitor, an organic or inorganic filler, metallic powder, particles, and/or a foil-form material.

Alternatively, the organic conductive membrane may be formed by subjecting a monomer for producing a conductive polymer to electrolytic polymerization onto a transparent substrate.

The thickness of the transparent conductive layer is not particularly limited, and is preferably from 10 to 1,000 nm, more preferably from 50 to 400 nm.

The method for forming the transparent conductive layer is not particularly limited, and may be a method known in the prior art. Specific examples thereof include vacuum evaporation, sputtering, and ion plating methods. When a coating liquid for the layer is applied, examples of the transparent-conductive-layer-forming method include micro gravure coating, roll coating, dip coating, flow coating, spin coating, die coating, cast transferring, and spray coating methods. When the transparent conductive layer is a metal mesh, this layer can be obtained, for example, by applying a silver-salt-containing photosensitive composition (composition for forming the transparent conductive layer) onto an adherend such as a release film, and then subjecting the resultant to light exposure treatment and development treatment to form fine lines of the metal into a predetermined pattern. The transparent conductive layer may also be yielded by printing a paste including metal fine particles (transparent-conductive-layer-forming composition) into a predetermined pattern. Moreover, an appropriate method is also adoptable in accordance with a required membrane thickness of the layer.

The pressure-sensitive-adhesive-layer-attached polarizing film may have, on its transparent conductive layer, an overcoat (OC) layer (not illustrated). As the overcoat layer, without any especial limitation, an overcoat layer used ordinarily in the present field is usable. The overcoat layer may be a layer made from, for example, an alkyd resin, acrylic resin, epoxy resin, urethane resin, or isocyanate resin. The thickness of the overcoat layer is not particularly limited, and is preferably, for example, from 0.1 to 10 μm.

The transparent substrate is sufficient to be a substrate having transparency. The material thereof is not particularly limited. The transparent substrate may be, for example, a glass or transparent resin film substrate. The transparent resin film substrate may be the same as described above.

Between the transparent conductive layer and the transparent substrate, for example, an under coat layer and/or an oligomer prevention layer may be laid.

### 4. Image Display Panel, Image Display Device

An image display panel of the present invention includes the pressure-sensitive-adhesive-layer-attached polarizing film and a transparent conductive substrate having a transparent conductive layer and a transparent substrate, and the pressure-sensitive-adhesive layer of the pressure-sensitive-adhesive-layer-attached polarizing film is bonded to the transparent conductive layer of the image display panel.

And an image display device of the present invention includes the image display panel.

The pressure-sensitive-adhesive-layer-attached polarizing film, and the transparent conductive substrate are as detailed above. The image display panel has the transparent conductive substrate detailed above, and is combined with the pressure-sensitive-adhesive-layer-attached polarizing film detailed above to form a partial moiety of an image display device.

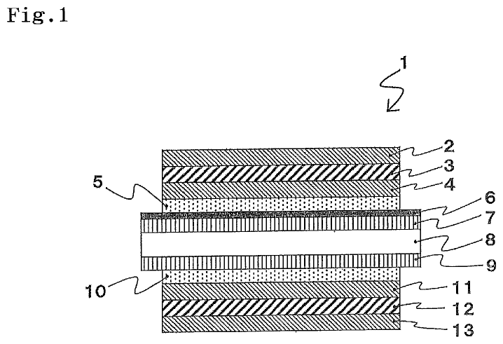

A description will be made hereinafter about a liquid crystal panel that is a typical embodiment of an image display panel to which the pressure-sensitive-adhesive-layer-attached polarizing film of the present invention is applied. The liquid crystal cell used in the liquid crystal panel has the above-mentioned transparent conductive substrate. The transparent conductive substrate is usually provided to the viewing side surface of the liquid crystal cell. With reference to FIG. 1, a description will be made about a liquid crystal panel including a liquid crystal cell usable in the present invention. However, the present invention is not limited to FIG. 1.

An embodiment of a liquid crystal panel 1, which can be included in the scope of the image display device of the present invention, may have a structure composed of the following members: a viewing side transparent protective film 2/a polarizer 3/a liquid crystal cell side transparent protective film 4/a pressure-sensitive-adhesive layer 5/a transparent conductive layer 6/a transparent substrate 7/a liquid crystal layer 8/a transparent substrate 9/a pressure-sensitive-adhesive layer 10/a liquid crystal cell side transparent protective film 11/a polarizer 12/a light source side transparent protective film 13, which are arranged in an order described herein from the viewing side of the structure. In FIG. 1, a pressure-sensitive-adhesive-layer-attached polarizing film of the present invention corresponds to the viewing side transparent protective film 2/the polarizer 3/the liquid crystal cell side transparent protective film 4/the pressure-sensitive-adhesive layer 5. In FIG. 1, a transparent conductive substrate used in the present invention is composed of the transparent conductive layer 6/the transparent substrate 7. In FIG. 1, a transparent-conductive-substrate-attached liquid crystal cell used in the present invention is composed of the transparent conductive layer 6/the transparent substrate 7/the liquid crystal layer 8/the transparent substrate 9.

Besides the above-mentioned constituents, the following may be appropriately provided to the liquid crystal panel 1: a retardant film, a viewing angle compensation film, a brightness enhancement film, or any other optical film.

The liquid crystal layer 8 is not particularly limited, and may be a liquid crystal layer in any mode such as a TN, STN, π, VA, or IPS mode. The (light source side) transparent substrate 9 is sufficient to be a substrate having transparency, and the material thereof is not particularly limited. The transparent substrate 9 is, for example, a glass or transparent resin film substrate. The transparent resin film substrate may be the same as described above.

The light source side pressure-sensitive-adhesive layer 10, the liquid crystal cell side transparent protective film 11, the polarizer 12 and the light source side transparent protective film 13 may be ones used conventionally in the present field. Those described in the present description are also preferably usable.

The liquid crystal panel 1 is a panel in which a pressure-sensitive-adhesive-layer-attached polarizing film of the present invention is laminated onto the transparent conductive layer 6, which is formed as an outermost layer on the viewing side of the liquid crystal cell to bring the transparent conductive layer 6 of the liquid crystal cell into contact with the pressure-sensitive-adhesive layer 5 of the pressure-sensitive-adhesive-layer-attached polarizing film.

The image display device of the present invention is sufficient to be an image display device including a pressure-sensitive-adhesive-layer-attached polarizing film of the present invention, and a liquid crystal cell equipped with a transparent conductive substrate having a transparent conductive layer over a transparent substrate. The image display device preferably includes the liquid crystal panel described just above. Hereinafter, as an example of the device, a description will be made about a liquid crystal display device. However, the present invention is not limited to this example.

Specific examples of an image display device to which the liquid crystal panel is applicable include liquid crystal display devices, electroluminescence (EL) displays, plasma displays (PDs), and field emission displays (FEDs).

The image display device of the present invention is sufficient to be an image display device including a pressure-sensitive-adhesive-layer-attached polarizing film of the present invention, and a liquid crystal cell equipped with a transparent conductive substrate having a transparent conductive layer over a transparent substrate. Other constituents of the device may be the same as in any conventional image display device.

### EXAMPLES

Hereinafter, the present invention will be specifically described by way of examples thereof. However, the present invention is not limited to the examples. Conditions for allowing any member to stand still at room temperature are 23° C. and 65% R.H. unless otherwise specified.

<Measurement of Weight-Average Molecular Weight of (Meth) acryl-based Polymer>

The weight-average molecular weight (Mw) of any (meth)acryl-based polymer is measured by GPC (gel permeation chromatography). The Mw/Mn ratio is also measured in the same way.

Analyzer: HLC-8120 GPC, manufactured by Tosoh Corporation

Columns: G7000HXL+GMHXL+GMHXL, each manufactured by Tosoh Corporation

Column size: each of the columns that has a size of 7.8 mm diameter and 30 cm; total: 90 cm

Column temperature: 40° C.

Flow rate: 0.8 mL/min.

Injected amount: 100 μL

Eluent: tetrahydrofuran

Detector: refractive index detector (RI)

Standard sample: polystyrene.

### Production Example 1 (Production of Polarizing Film)

A polyvinyl alcohol film of 80 μm in thickness was stretched to a stretch ratio of 3 between rolls different in velocity ratio from each other while dyed in an iodine solution having a concentration of 0.3% by weight at 30° C. for 1 minute. Thereafter, the film was stretched to a total stretch ratio of 6 while immersed into an aqueous solution containing boric acid at a concentration of 4% by weight and potassium iodide at a concentration of 10% by weight at 60° C. for 0.5 minute. Next, the film was immersed into an aqueous solution containing potassium iodide at a concentration of 1.5% by weight at 30° C. for 10 seconds to be washed. Thereafter, the film was dried at 50° C. for 4 minutes to yield a polarizer of 30 μm in thickness. Triacetylcellulose films subjected to saponifying treatment and each having a thickness of 80 μm were bonded, respectively, to both surfaces of the polarizer through a polyvinyl alcohol based adhesive to produce a polarizing film.

### Production Example 2 (Preparation of Acrylic Polymer (a-1) Solution)

Into a four-necked flask equipped with an impeller, a thermometer, a nitrogen-gas-introducing tube and a condenser was charged a monomer mixture containing 99 parts by weight of butyl acrylate and 1 part by weight of 4-hydroxybutyl acrylate. Furthermore, to 100 parts by weight of (any solid in) the monomer mixture was charged 0.1 part by weight of 2,2′-azobisisobutyronitrile as a polymerization initiator together with 100 parts by weight of ethyl acetate. While this reaction system was gently stirred, nitrogen gas was introduced thereinto to purge the inside in the flask with nitrogen. Thereafter, the temperature of the liquid inside the flask was kept at about 55° C. to cause the monomer components to undergo polymerization reaction for 8 hours to prepare a solution of an acrylic polymer (a-1) having a weight-average molecular weight (Mw) of 1,560,000 and a Mw/Mn ratio of 3.2.

### Production Examples 3 to 5

Acrylic polymer (a-2) to (a-4) solutions were each prepared in the same way as in Production Example 2 except that in Production Example 2, the monomer species used to prepare the acrylic polymer, and the respective proportions of the species were changed as shown in Table 1.

TABLE 1

| | Acrylic | Blend amounts (part(s) by weight) | | | | | |
|---|---|---|---|---|---|---|---|
| | polymer | BA | NVP | AA | HBA | MW | Mw/Mn |
| Production example 2 | (a-1) | 99 | — | — | 1 | 156 | 3.2 |
| Production example 3 | (a-2) | 99.3 | — | 0.3 | 0.4 | 162 | 3.4 |
| Production example 4 | (a-3) | 99.3 | 1.5 | — | 0.4 | 161 | 3.5 |
| Production example 5 | (a-4) | 97.8 | 1.5 | 0.3 | 0.4 | 155 | 3.7 |

Abbreviations in Table 1 are each as follows.
BA: butyl acrylate
NVP: N-vinyl-2-pyrrolidone
AA: acrylic acid
HBA: 4-hydroxybutyl acrylate

### Example 1

### (Preparation of Acrylic Pressure-Sensitive-Adhesive Composition)

Into 100 parts by weight of the solid in the acrylic polymer (a-1) solution yielded in Production example 2 were blended 0.1 part of an isocyanate crosslinking agent (trimethylolpropanehexamethylene diisocyanate; trade name: TAKENATE D160N, manufactured by Mitsui Chemicals, Inc.), 0.3 part of benzoyl peroxide (NYPER BMT 40SV, manufactured by NOF Corporation), and 0.3 part of an 3-mercaptopropyltrimethoxysilane (trade name: KBM-803, manufactured by Shin-Etsu Chemical Co., Ltd.; alkoxy group quantity: 47% by weight; thiol equivalent: 196 g/mol) to prepare a solution of an acrylic pressure-sensitive-adhesive composition.

### (Production of Pressure-Sensitive-Adhesive-Layer-Attached Polarizing Film)

The acrylic pressure-sensitive-adhesive composition solution was coated onto one surface of a polyethylene terephthalate film (separator film; trade name: MRF38, manufactured by Mitsubishi Polyester Film, Inc.) treated with a silicone release agent to give a pressure-sensitive-adhesive layer having a thickness of 23 μm after the workpiece was to be dried. The workpiece was then dried at 155° C. for 1 minute. In this way, the pressure-sensitive-adhesive layer was formed on the surface of the separator film. Next, the pressure-sensitive-adhesive layer formed on the separator film was transferred onto the polarizing film produced in Production Example 1 to produce each pressure-sensitive-adhesive-layer-attached polarizing film.

### Examples 2 to 13, and Comparative Examples 1 to 5

In each of these examples, a solution of an acrylic pressure-sensitive-adhesive composition was prepared in the same way as in Example 1 except that in Example 1, one or more factors of kind of the acrylic polymer, kind of the silane coupling agent, and respective addition amounts thereof were changed as shown in Table 2. In Example 12, an ionic compound was blended into the composition in a proportion shown in Table 2. The resultant acrylic pressure-sensitive-adhesive composition for each of the examples was used to produce each pressure-sensitive-adhesive-layer-attached polarizing film in the same manner as in Example 1.

About the pressure-sensitive-adhesive-layer-attached polarizing films yielded in the examples and the comparative examples, evaluations described below were made. The evaluation results are shown in Table 2.

### <Preparation of Evaluating Samples>

The pressure-sensitive-adhesive-layer-attached polarizing film yielded in each of the examples and the comparative examples was cut into two pieces each having a size of 15 inches. The pieces were used as samples. The samples were bonded to the transparent-conductive-layer-attached glass pieces, respectively. The transparent-conductive-layer-attached glass pieces were an ITO-layer-attached glass piece having an amorphous ITO layer on a non-alkali glass piece (trade name: EG-XG, manufactured by Corning Inc.) having a thickness of 0.7 mm, and an organic-conductive-membrane-attached glass piece having an organic conductive membrane on the same non-alkali glass piece as described above. The above-mentioned bonding of one of the samples and that of the other sample were to the ITO layer of the ITO-layer-attached glass piece, and the organic conductive membrane of the organic-conductive-membrane-attached glass piece, respectively, using a laminator. Next, the resultants were subjected to autoclave treatment at 50° C. and 0.5 MPa for 15 minutes to cause the samples to adhere completely to the ITO-layer-attached glass piece and the organic-conductive-membrane-attached glass piece, respectively.

Each of the ITO layers was formed by sputtering. About the composition of the compound ITO, the proportion of Sn was 3% by weight. Before the bonding of each of the samples, the sample was put into a heating step at 140° C. for 60 minutes. The proportion of Sn of ITO was calculated out in accordance with the expression, Sn atom weight/(Sn atom weight+In atom weight). The formation of the organic conductive membrane on the glass piece was attained by a spin coating method using a coating liquid containing a polyethylenedioxythiophene/polystyrenesulfonic acid salt.

### <Endurance Test Immediately After Coating>

The thus-treated samples were subjected to humidifying treatment in an atmosphere of 60° C. temperature and 95% RH for 500 hours (in a humidifying test). Thereafter, in accordance with a criterion described below, evaluation was visually made about the external appearance of the interface between the polarizing film of one of the samples and the ITO-layer-attached glass piece thereof, and that of the interface between the polarizing film of the other sample and the organic-conductive-membrane-attached glass piece thereof.

### (Evaluation Criterion)

⊙: A change in the external appearance, such as a peel, was not caused at all.

◯: An edge of the sample was slightly peeled, but no problem was caused for practical use.

Δ: An edge of the sample was peeled, but no problem was caused for practical use unless the sample was used for an special purpose.

x: An edge of the sample was remarkably peeled so that a problem was caused for practical use.

### <Adhering Strength>

The pressure-sensitive-adhesive-layer-attached polarizing film yielded in each of the examples and the comparative examples was cut into pieces each having a width of 25 mm. The resultants were used as evaluating samples. Except the use, the same operations as in the above-mentioned item <Preparation of Evaluating Samples> were made to bond the samples to transparent-conductive-layer-attached glass pieces (i.e., an ITO-layer-attached glass piece and an organic-conductive-membrane-attached glass pieces), respectively. The resultants were subjected to the same treatment as described above to cause the pressure-sensitive-adhesive-layer-attached polarizing films to adhere completely to the respective transparent-conductive-layer-attached glass pieces (initial-stage samples).

Thereafter, the thus-treated samples were subjected to heating treatment under dry conditions at 60° C. for 48 hours (after-heating samples). The adhering strength of each of the samples was measured. The adhering strength was gained by measuring the adhering strength (N/25-mm) of the sample when a tensile tester (Autograph SHIMAZU AG-1 1OKN, manufactured by Shimadzu Corp.) was used to peel off the sample at a peeling angle of 90° C. and a peel rate of 300 mm/min. In the measurement, measured values were sampled at intervals of one time/0.5-second. The average of the resultant values was used as the measured value of the sample.

### <Re-Workability>

The pressure-sensitive-adhesive-layer-attached polarizing film yielded in each of the examples and the comparative examples was cut into pieces each having a size of 350 mm length and 250 mm width. The resultants were used as evaluating samples. Except the use, the same operations as made for the above-mentioned adhering-strength-measuring targets were made. About each of the samples, the sample was peeled off from the transparent-conductive-layer-attached glass piece by hand, and then the re-workability thereof was evaluated in accordance with a criterion described below. About the re-workability evaluation, through the same step as described above, three evaluating samples were produced in total, and the evaluation was repeated 3 times.

⊙: about each of the three samples was satisfactorily peelable without generating any residue of the adhesive nor causing the breaking of the film.

◯: about one or two of the three samples, the film was broken out, but peeled by making a peeling operation again.

Δ: about each of the three samples, the film was broken out, but peeled by making a peeling operation again.

x: about each of the three samples, a residue of the adhesive was generated, or the film was broken out not to be peelable even by making a peeling operation many times.

TABLE 2

| | Pressure-sensitive adhesive composition | | | | | | | |
|---|---|---|---|---|---|---|---|---|
| | | Crosslinking agent | | Silane coupling agent | | | | |
| | | Isocyanate - | Peroxide - | | | Alkoxy group | Addition | Ionic |
| | (Meth) | based | based | | Thiol | quantity | amount | compound |
| | acryl-based | (part by | (part by | | equivalent | (% by | (part by | (part by |
| | polymer | weight) | weight) | Kinds | (g/mol) | weight) | weight) | weight) |
| Example 1 | (a-1) | 0.1 | 0.3 | KBM-803 | 196 | 47 | 0.3 | — |
| Example 2 | (a-1) | 0.1 | 0.3 | X-41-1805 | 800 | 50 | 0.3 | — |
| Example 3 | (a-1) | 0.1 | 0.3 | X-41-1818 | 850 | 60 | 0.3 | — |
| Example 4 | (a-1) | 0.1 | 0.3 | X-41-1810 | 450 | 30 | 0.3 | — |
| Example 5 | (a-1) | 0.1 | 0.3 | X-41-1810 | 450 | 30 | 0.05 | — |
| Example 6 | (a-1) | 0.1 | 0.3 | X-41-1810 | 450 | 30 | 1 | — |
| Example 7 | (a-1) | 0.1 | 0.3 | X-41-1810 | 450 | 30 | 6 | — |
| Example 8 | (a-2) | 0.1 | 0.3 | X-41-1810 | 450 | 30 | 0.3 | — |
| Example 9 | (a-3) | 0.1 | 0.3 | X-41-1810 | 450 | 30 | 0.3 | — |
| Example 10 | (a-4) | 0.1 | 0.3 | X-41-1810 | 450 | 30 | 0.3 | — |
| Example 11 | (a-4) | 0.1 | 0.3 | X-41-1805 | 800 | 50 | 0.3 | — |
| Example 12 | (a-4) | 0.1 | 0.3 | X-41-1818 | 850 | 60 | 0.3 | — |
| Example 13 | (a-4) | 0.1 | 0.3 | X-41-1810 | 450 | 30 | 0.3 | 1 |
| Comparative | (a-1) | 0.1 | 0.3 | — | — | — | — | — |
| Example 1 | | | | | | | | |
| Comparative | (a-1) | 0.1 | 0.3 | KBM-403 | — | 39 | 0.3 | — |
| Example 2 | | | | | | | | |
| Comparative | (a-1) | 0.1 | 0.3 | X-41-1056 | — | 17 | 0.3 | — |
| Example 3 | | | | | | | | |
| Comparative | (a-2) | 0.1 | 0.3 | X-41-1056 | — | 17 | 0.3 | — |
| Example 4 | | | | | | | | |
| Comparative | (a-3) | 0.1 | 0.3 | X-41-1056 | — | 17 | 0.3 | — |
| Example 5 | | | | | | | | |

| | | | | | Toward organic-conductive- | | | |
|---|---|---|---|---|---|---|---|---|
| | Toward ITO-layer-attached glass piece | | | | membrane-attached glass piece | | | |
| | | Adhering strength | | | | Adhering strength | | |
| | | (N/25 mm) | | | | (N/25 mm) | | |
| | | | Sample at | | | | Sample at | |
| | Endurance | Initial - | 60° C. | Re- | Endurance | Initial - | 60° C. | Re- |
| | 60° C./ | stage | after | working | 60° C./ | stage | after | working |
| | 95% RH | sample | 48 hours | test | 95% RH | sample | 48 hours | test |
| Example 1 | Δ | 4 | 7 | ⊙ | ⊙ | 4.2 | 10.8 | ⊙ |
| Example 2 | Δ | 4.4 | 7 | ⊙ | ⊙ | 3.2 | 10.2 | ⊙ |
| Example 3 | Δ | 4.5 | 6.9 | ⊙ | ⊙ | 3 | 9.5 | ⊙ |
| Example 4 | ◯ | 4.8 | 7.2 | ⊙ | ⊙ | 3.6 | 11 | ⊙ |
| Example 5 | ◯ | 5.4 | 6.8 | ⊙ | ⊙ | 4.8 | 8.7 | ⊙ |
| Example 6 | ◯ | 4.3 | 7.3 | ⊙ | ⊙ | 3.3 | 12.2 | ◯ |
| Example 7 | ◯ | 3 | 6.1 | ⊙ | ◯ | 2.9 | 10.2 | Δ |
| Example 8 | ⊙ | 6 | 7.9 | ⊙ | ⊙ | 4 | 9.8 | ⊙ |
| Example 9 | ⊙ | 6.2 | 8.3 | ⊙ | ⊙ | 4.3 | 10.8 | ⊙ |
| Example 10 | ⊙ | 6 | 8.2 | ⊙ | ⊙ | 4.8 | 10.4 | ⊙ |
| Example 11 | ◯ | 5.3 | 6.9 | ⊙ | ⊙ | 4.5 | 10.1 | ⊙ |
| Example 12 | ◯ | 5.8 | 7.1 | ⊙ | ⊙ | 4.2 | 11.1 | ⊙ |
| Example 13 | ⊙ | 6 | 7.5 | ⊙ | ⊙ | 3.9 | 9.9 | ⊙ |
| Comparative | X | 5.8 | 6.3 | ⊙ | X | 5.9 | 11.8 | ⊙ |
| Example 1 | | | | | | | | |
| Comparative | X | 4 | 6.9 | ⊙ | ◯ | 6.6 | 12.7 | ◯ |
| Example 2 | | | | | | | | |
| Comparative | ◯ | 4.9 | 9.2 | ⊙ | ⊙ | 17.1 | 19.9 | X |
| Example 3 | | | | | | | | |
| Comparative | ⊙ | 6.9 | 12.4 | ◯ | ⊙ | 16.6 | 21.6 | X |
| Example 4 | | | | | | | | |
| Comparative | ⊙ | 6.3 | 12.9 | ◯ | ⊙ | 17.9 | 20.7 | X |
| Example 5 | | | | | | | | |

In Table 2, abbreviations were each as follows: Isocyanate based: trimethylolpropanehexamethylene diisocyanate, trade name TAKENATE D160N, manufactured by Mitsui Chemicals, Inc.;

Peroxide based: benzoyl peroxide, trade name: NYPER BMT 40SV, manufactured by NOF Corporation;

KBM-803: 3-mercaptopropyltrimethoxysilane, manufactured by Shin-Etsu Chemical Co., Ltd.; alkoxy group quantity: 47% by weight; thiol equivalent: 196 g/mol;

X-41-1805: oligomer thiol-group-containing silane coupling agent, manufactured by Shin-Etsu Chemical Co., Ltd.; alkoxy group quantity: 50% by weight; thiol equivalent: 800 g/mol;

X-41-1818: oligomer thiol-group-containing silane coupling agent, manufactured by Shin-Etsu Chemical Co., Ltd.; alkoxy group quantity: 60% by weight; thiol equivalent: 850 g/mol;

X-41-1810: oligomer thiol-group-containing silane coupling agent, manufactured by Shin-Etsu Chemical Co., Ltd.; alkoxy group quantity: 30% by weight; thiol equivalent: 450 g/mol;

KBM403: γ-glycidoxypropylmethoxysilane, manufactured by Shin-Etsu Chemical Co., Ltd.; alkoxy group quantity: 39% by weight;

X-41-1056: oligomer epoxy-group-containing silane coupling agent, manufactured by Shin-Etsu Chemical Co., Ltd.; alkoxy group amount proportion: 17% by weight, and epoxy equivalent: 280 g/mol; and

Ionic compound: bis(trifluoromethanesulfonylimide) lithium, manufactured by Mitsubishi Materials Corporation.

### DESCRIPTION OF REFERENCE SIGNS

1: Liquid crystal panel
2: Viewing side transparent protective film
3: Polarizer
4: Liquid crystal cell side transparent protective film
5: Pressure-sensitive-adhesive layer
6: Transparent conductive layer
7: Transparent substrate
8: Liquid crystal layer
9: Transparent substrate
10: Pressure-sensitive-adhesive layer
11: Liquid crystal cell side transparent protective film
12: Polarizer
13: Light source side transparent protective film

What is claimed is:

1. A pressure-sensitive-adhesive-layer-attached polarizing film for a transparent conductive layer comprising:
a pressure-sensitive adhesive layer and a polarizing film;
wherein the transparent conductive layer is a layer made of an organic conductive membrane, and
a pressure-sensitive adhesive composition for forming the pressure-sensitive adhesive layer comprises a (meth)acryl-based polymer and a thiol-group-containing silane coupling agent.

2. The pressure-sensitive-adhesive composition according to claim 1, wherein the thiol-group-containing silane coupling agent is an oligomer thiol-group-containing silane coupling agent.

3. The pressure-sensitive-adhesive composition according to claim 1, wherein the thiol-group-containing silane coupling agent has, in molecule thereof, two or more alkoxysilyl groups.

4. The pressure-sensitive-adhesive composition according to claim 1, wherein the blend amount of the thiol-group-containing silane coupling agent is from 0.01 to 3 parts by weight for 100 parts by weight of the (meth)acryl-based polymer.

5. The pressure-sensitive-adhesive composition according to claim 1, wherein the thiol-group-containing silane coupling agent has an thiol equivalent of 700 g/mol or less.

6. An image display panel, comprising: the pressure-sensitive-adhesive-layer-attached polarizing film according to claim 1; and a transparent conductive substrate having a transparent conductive layer and a transparent substrate;
wherein the transparent conductive layer is layer made of an organic conductive membrane, and
the pressure-sensitive-adhesive layer of the pressure-sensitive-adhesive-layer-attached polarizing film is bonded to the transparent conductive layer of the image display panel.

7. An image display device, comprising: the image display panel according to claim 6.
